(19) United States
(12) Patent Application Publication
(10) Pub. No.: US 2004/0083277 A1
(43) Pub. Date: Apr. 29, 2004

(54) Method for fast cost-effective internet network topology design

(75) Inventors: P.S. Chaporkar, Nagpur (IN); D. Nandita, Palo Alto, CA (US); Joy Kuri, Bangalore (IN); Anurag Kumar, Bangalore (IN)

Correspondence Address: John M. Kelly, Esq., The Law Firm of John M. Kelly, 2117 L Street, NW #347, Washington, DC, 20037, US

(73) Assignee: Himachal Futuristic Communications Limited (HFCL)

(21) Appl. No.: 10/614,683

(22) Filed: Jul. 7, 2003

(30) Foreign Application Priority Data
Jul. 9, 2002 (IN) 727/DEL/2002

(51) Int. Cl. G06F 15/177

(52) U.S. Cl. 709/220

(57) ABSTRACT

A method of designing a network for an Internet Service Provider (ISP) is taught. The ISP provides routers that handle predetermined traffic demands and that are connected by links. An ordered sequence of (source-destination) pairs of routers is obtained. A particular (source-destination) pair and a minimum capacity on each potential link for the predicted traffic demands on the selected (source-destination) pair are selected. The differential cost of the link is then found, followed by a determination of the least-cost path for the selected (source-destination) pair. The current capacity and current cost of the network are then updated. The process repeats for all (source-destination) pairs in the ordered sequence. Least-cost paths can be determined using the Bellman-Ford method. The output of the basic method can be further refined by the Link Removal Heuristic (LRH) method, and/or a Flow Removal Heuristic (FRH) method.

### CROSS-REFERENCE TO RELATED APPLICATIONS

Not Applicable.

### BACKGROUND OF THE INVENTION

1. Field of the Invention

This invention relates to a fast, cost-effective method of designing an internet network.

2. Discussion of the Related Art

Network design and management are fundamental problems faced by Internet Service Providers (ISPs). The network design problem must address at least the following issues:

a. Deciding where to place the routers that act as Points of Presence (PoPs) of the ISP;

b. Interconnecting the routers, thus forming the network topology;

c. Determining the capacities of the interconnecting links; and

d. Determining aggregate flow routing, that is, the path taken by aggregate flows between source routers and destination routers.

For an ISP designing a network, a natural granularity for measuring traffic is aggregate flows, not individual session micro-flows. Thus, routing predominantly refers to routing aggregates between source-destination pairs.

Deciding where PoPs should be located is mostly an administrative issue, with resource and infrastructure availability being primary concerns. For example, PoPs are usually located in metropolitan cities where resource and infrastructure levels are higher than in towns and villages. Once the PoP locations have been decided, a new ISP needs to predict the traffic that will be flowing between pairs of PoPs. However, this invention does not directly relate to the problems of PoP locations and traffic predictions.

One design objective of a new ISP is to provide a network that costs the least while supporting the predicted traffic flow requirements. Network costs are determined by (a) the cost of routing equipment (routers, switches and associated equipment), and (b) the cost of the interconnecting links, which are normally leased from a bandwidth provider. In practice, the cost of interconnecting links is controlled by two main factors: (i) the length of a link joining the routers, and (ii) the capacity of the link.

Effective management of an existing ISP network may call for capacity expansion. In this scenario, the ISP already has a deployed network, but traffic growth necessitates more capacity. In such cases, the ISP must decide (a) whether to add a link between two routers, and if so, what capacity the link should have, or (b) whether to simply upgrade an existing link to one of higher capacity. Of course, one design objective is to upgrade the network at least cost.

The network design problem is more involved than merely obtaining a feasible network at least cost. Additional constraints arise from the following requirements:

a. Guaranteed performance: Network design may be influenced by performance guarantees that the ISP may want to announce as part of its service offering (for example: a minimum average assured rate for file downloads through its network). Such guaranteed performance may require the use of higher capacity links.

b. No flow splitting: An aggregate flow from a source-router to a destination-router must be carried along a single path only, and cannot be split among multiple paths. This constraint may be imposed by routing technology.

c. Symmetric routing: The aggregate flow between router i and router j, and the aggregate flow from router j to router i must use the same path in opposite directions..

d. Hop-constrained routing: The maximum number of hops on the path of any aggregate flow must not be greater than a specified hop-count.

e. Survivability: Occasional router or link failures should not cause service interruptions. This indicates the need for spare network capacity.

For example, there should be at least 2 independent paths between any router pair.

The problem of designing the minimum cost network, given the cost and traffic requirement constraints, can be formulated as an integer linear program. This problem has been shown to be NP-complete. Since a direct solution is computationally very expensive, efforts have been made to obtain “indirect” but nonetheless useful solutions to the design problem. For example, upper and lower bounds of an optimal cost design have been obtained in some cases. Heuristic and approximate solutions have also been tried.

The uncapacitated network design problem, which is concerned with providing connectivity among nodes at minimum cost, has previously been addressed. Each link has a certain cost associated with it; with that cost being dependent on the link distance. Since this is an uncapacitated problem, traffic constraints are not provided for. A tight lower bound to the optimal cost is readily obtained by a dual ascent procedure.

The problem of capacitated network design for multi-commodity flows has also been considered. Capacities are available in multiples of a base unit, with a lower bound to the optimal cost being given by a branch and bound heuristic. An upper bound has also been obtained using a polyhedral cutting plane technique.

Several papers have considered such problems and some advance approximation techniques. When capacities are restricted to 2 values, an iterative algorithm based on facet defining inequalities as cutting planes have been used. Optimization techniques for designing survivable networks have also been discussed.

Therefore, while others have addressed the design problem in a variety of ways, in reality they have addressed simplified versions of the general topology design problem. The general problem can include some or all of the additional requirements listed in points (a) to (e) above. Furthermore, even the simplified versions are difficult to solve. Therefore, throwing in additional requirements makes the problem extremely difficult. Designing heuristic algorithms seems like the only practical option.

One such heuristic algorithm, named MENTOR (MEsh Network Topology Optimization and Routing), has been used. It is a heuristic algorithm that finds a minimum cost network that supports a set of given traffic constraints. However, MENTOR has several limitations: (a) link capacities are restricted to 1 value only, (b) the cost of a link obeys the triangle inequality, and (c) flow splitting to an arbitrary granularity is assumed. Additional requirements like survivability and hop constraints cannot be incorporated. Also, the algorithm cannot start with any partial topology; so problems like cost effective capacity expansion also cannot be addressed. This motivates the need for a more flexible heuristic.

Therefore, a new method of designing network topologies would be beneficial. Even more beneficial would be a new method of designing network topologies that includes the ability to satisfy given traffic requirements such as hop and connectivity constraints at low, and possibly at least, cost.

### SUMMARY OF THE INVENTION

Accordingly, the principles of the present invention are directed to a new method of designing a network for an Internet Service Provider (ISP) having routers that handle predetermined traffic demands and that are connected by links. An ordered sequence of (source-destination) pairs of routers is obtained. A particular (source-destination) pair is then selected. Then, a minimum capacity for the predicted traffic demands on the selected (source-destination) pair is established. The differential cost of the link is then found, followed by a determination of the least-cost path for the selected (source-destination) pair. The current capacity and current cost of the network are then updated. If the selected (source-destination) pair is not the last (source-destination) pair in the ordered sequence of (source-destination) pairs, another (source-destination) pair is selected and the process repeats until all (source-destination) pairs have been processed.

Beneficially, the step of determining the least-cost path uses the Bellman-Ford method. Additional steps, such as a subsequently described Link Removal Heuristic (LRH) method and a Demand Removal Heuristic (DRH) method can also be used.

Additional features and advantages of the invention will be set forth in the description that follows, and in part will be apparent from that description, or may be learned by practice of the invention.

### BRIEF DESCRIPTION OF THE DRAWING

The accompanying drawings, which are included to provide a further understanding of the invention and which are incorporated in and constitute a part of this specification, illustrate various embodiments of the invention and together with the description serve to explain the principles of the invention.

FIG. 1 illustrates a block flow diagram of a design method that is in accord with the principles of the present invention; and

FIG. 2 illustrates both the time required by the method illustrated in FIG. 1 to obtain a network topology design solution given various network sizes and the time required to achieve an optimal solution to a network having a small number of nodes.

### DETAILED DESCRIPTION OF THE ILLUSTRATED EMBODIMENT

The principles of the present invention provide for an inventive method of designing network topologies. Beneficially, that inventive method includes the ability of satisfying given traffic requirements such as hop and connectivity constraints at low, and possibly at least, cost.

The inventive method assumes that certain information is available. In particular:

a. Information regarding PoPs, specifically including the positions of the nodes and the distance between any 2 of the PoPs.

b. Information regarding the traffic matrix, specifically including the predicted traffic between any 2 nodes.

c. Information regarding all the available link capacities.

d. Information regarding the overall cost matrix: that is, a 3-dimensional matrix that contains the cost of a link of capacity C between any 2 nodes, with the value C being selected from a set of available capacities.

Given n nodes, there can be at most n(n−1) directed links in the network. These can be thought of as “potential” links in the sense that the algorithm chooses some links from this set of potential links for interconnecting the given nodes. Each potential link has 2 variables associated with it: current_capacity and current_traffic, both of which are typically initialized to zero for each potential link. However, for a network upgrade problem, each link in the existing topology has its current capacity and current traffic initialized to its present value, while all other potential links have their variables initialized to zero.

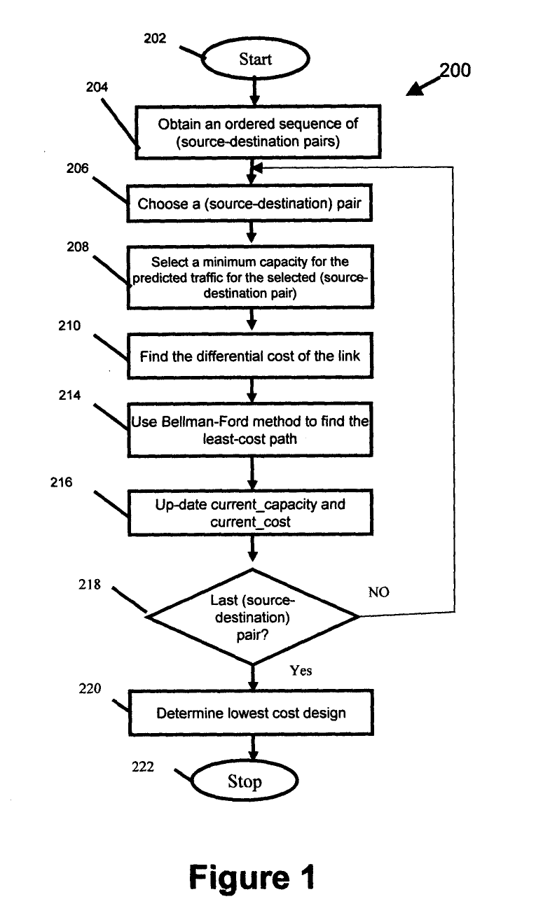

FIG. 1 illustrates a method of designing an internet network that is in accord with the principles of the present invention. That method starts, step 202, and proceeds by obtaining an ordered sequence of (source, destination) pairs, step 204. This ordered sequence is based on the network PoPs and on selected design criteria (see below). A particular (source, destination) pair is then selected from the sequence, step 206. For each potential link, a minimum capacity is selected (from a set of available capacities such as supplied by a component catalog) based on the assumption that the predicted traffic for that (source, destination) pair flows through that link, step 208. Then, the differential cost of the link of found based on the cost difference between the required minimum capacity and the present capacity of the link, step 210.

Then, the Bellman-Ford method is used to find the least-cost hop-constrained path from the source to the destination, with the link metrics being the differential costs, step 214. The Bellman-Ford method is a well-known procedure found in textbooks. Reference can be made to, for example, “Data Networks,” by Dimitri Bertsekas and Robert Gallager, published by Prentice-Hall of India, New Delhi (1989). The found path will then be used to route the traffic for the (source, destination) pair. Then, for every link on the selected path, the current capacity and the current cost data is updated, step 216. A decision is then made, step 218, as to whether the particular (source, destination) pair was the last pair in the ordered sequence. If it was, then the lowest cost design has been determined, step 220, and the method then stops, step 222. However, if the selected pair was not the last pair in the sequence, a loop is made back to step 206 for selection and processing using another (source, destination) pair. The process repeats until all (source, destination) pairs have been processed.

At any iteration, the aim of the method is to augment the current topology such that the predicted traffic requirement between the chosen (source, destination) pair can be supported with minimum additional cost.

Note that no specific criterion for ordering the node pairs has been specified. Several orderings are possible, with each such ordering leading to a variant of the method. Usually, the link cost is seen to be concave with respect to both distance and the capacity of the link. Therefore, a good ordering criterion should utilize this concavity.

The method described above is “greedy” in the sense that it seeks to minimize the incremental cost during each iteration. However, it may be possible to further improve the cost of the topology. Two methods are provided for below.

The first method, referred to as the “Link Removal Heuristic” (LRH), attempts to reduce the overall cost by further refining the topology. The basic idea is to explore possible reductions in cost by removing one link at a time. The aggregate flow passing through the removed link is re-routed through the remaining links. If removal of a particular link together with the cost of consequent re-routing result in decreased topology cost, then that link is removed. These steps can then be repeated for each link.

The second method, named “Flow Removal Heuristic” (FRH), attempts to reduce cost in a different way. Suppose the original topology cost is T-old. The idea is to remove a flow from the network and obtain a possibly modified topology with possibly lower cost. Now, with this modified topology as a starting topology, we attempt to put back and route the flow that was removed. This may result in a new topology (since additional capacity may be required on some links) with a cost T-new. If T-new is less than T-old, then the new topology is retained. All flows are examined one by one in the above way.

The issue of survivable topologies is, in general, quite complicated. Therefore, what follows is restricted to a single link failure only. The general requirement is to have alternative paths for connections passing through a failed link. Clearly, this implies that additional capacity must be installed on the links of the network, with least cost being the objective.

One method of obtaining topologies that survive single link failures is based on the method described in steps (a) to (d) above. The starting topology is provided by the output of the basic method. Suppose one link in this topology falls. Then, the traffic flowing though that link must be re-routed on the remaining links. The basic method is used again to explore different paths that can carry the traffic passing through the failed link, with the least cost path being chosen. The above process is repeated for every link in the starting topology.

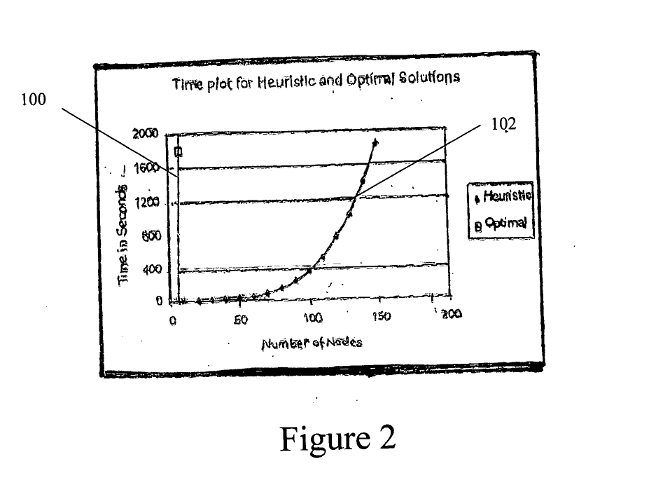

To estimate the quality of the proposed method, several example problems in topology design were considered. For “small” problems, it is possible to obtain the optimal cost by solving an Integer Linear Program. The cost of a design obtained from the inventive method was compared to the optimal cost. For all small problems for which the optimal costs were computable, there was no difference between the optimal cost and the cost of the design given by the inventive method. This indicates that the inventive method performs well. A key advantage in using the inventive method is the speed with which designs are obtainable. This is shown in FIG. 2.

FIG. 2 illustrates graphs of the time in seconds, Y-axis, versus the number of nodes, X-axis, when obtaining solutions according to the optimal method, graph 100, and the inventive heuristic method, graph 102. It can be seen that the time required to obtain the optimal solution is very high, even with a small number of nodes (say 10). However, the inventive method is much less time constrained. Indeed, the optimal solution becomes very impractical, likely numerically impossible to actually solve, as the number of nodes increases.

The embodiments and examples set forth herein are presented to explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered. The description as set forth is not intended to be exhaustive or to limit the scope of the invention. Many modifications and variations are possible in light of the above teaching without departing from the spirit and scope of the following claims. It is contemplated that the use of the present invention can involve components having different characteristics. It is intended that the scope of the present invention be defined by the claims appended hereto, giving full cognizance to equivalents in all respects.

What is claimed is:

1. A method for designing a network for an Internet Service Provider (ISP) having routers that handle predetermined traffic demands and that are connected by links, the method comprising the steps of:
(a) obtaining an ordered sequence of (source-destination) pairs of routers;
(b) selecting a particular (source-destination) pair;
(c) selecting a minimum capacity for the predicted traffic demands of the selected (source-destination) pair on each potential link;
(d) finding the differential cost of the link;
(e) determining the least-cost path for the selected (source-destination) pair; and
(f) updating the current capacity and current cost of the network.

2. The method according to claim 1, further including a step (g) of determining if the particular (source-destination) pair selected in step (b) is the last (source-destination) pair in the ordered sequence of (source-destination) pairs.

3. The method according to claim 2, further including looping back to step (b) to select another particular (source-destination) pair.

4. The method according to claim 1, wherein the step of determining the least-cost path uses the Bellman-Ford method.

5. The method according to claim 1, wherein the step of determining the final network design includes using the Link Removal Heuristic (LRH) method.

6. The method according to claim 1, wherein the step of determining the final network design includes using the Flow Removal Heuristic (FRH) method.

7. A fast method for obtaining a low-cost, and possibly least cost, backbone network forming the basic infrastructure of an Internet Service Provider (ISP)
(a) consisting of the routers and the links administered and operated by the ISP—over a given set of router locations, given a traffic demand matrix, the said traffic originating from the demands of the ISP's customers, and a link distance—bandwidth cost matrix, the said cost matrix being given by a bandwidth provider, comprising
(b) providing sequential addition of traffic demands, each demand being routed over a minimum weight path, where all possible links given the router locations are considered and the link weights are assigned, for each demand by a differential cost analysis,
(c) ensuring that a demand between any ingress router and egress router (referred to as an “ingress-egress pair”) is not split,
(d) ensuring symmetric routing of demands between any ingress-egress pair,
(e) ensuring hop-constrained routing, viz., that a demand between any ingress-egress pair traverses at most a pre-specified number of hops.

8. The method as claimed in claim 7, wherein the said method includes two additional methods, named Link Removal Heuristic (LRH) and Flow Removal Heuristic (FRH) that reduce cost by further refinements to the network, the said refinements being obtained by the following steps:
a) removal of a link (flow) from the network
b) updation of the network such that the removal link (flow) can be re-inserted into the network at least incremental cost.

9. The method as claimed in claim 7, wherein the said method is followed by the Surviving Single Link Failures Heuristic (SSLFH) method which incorporates survivability constraints in the design, by providing alternate paths for connections passing through a failed link, and thereby ensures sufficient spare capacity that is used in the event of single link failures, the said method consisting of a repeated application of the following steps:
a. removal of a link from the network,
b. re-routing of all demands that were routed through the above link such that the re-routing can be accomplished at least incremental cost.
